(19) United States
(12) Patent Application Publication
(10) Pub. No.: US 2023/0241436 A1
(43) Pub. Date: Aug. 3, 2023

(54) CARTRIDGE-OPERATED FIRE EXTINGUISHER

(71) Applicant: Carrier Corporation, Palm Beach Gardens, FL (US)

(72) Inventor: Wieslaw Wieczerzak, Czermin (PL)

(21) Appl. No.: 18/160,591

(22) Filed: Jan. 27, 2023

(30) Foreign Application Priority Data
Jan. 28, 2022 (EP) 22154079.2

(51) Int. Cl. A62C 13/74; A62C 13/76; A62C 13/00; A62C 37/50

(52) U.S. Cl. CPC A62C 13/74; A62C 13/76; A62C 13/003; A62C 37/50

(57) ABSTRACT

A cartridge-operated fire extinguisher comprising a gas cartridge 124 for storing pressurised fluid 126 therein, and a spear 150 moveable from an initial first position in a first direction to pierce the gas cartridge 124, and moveable in a second direction to a second position to thereby indicate that pressurised fluid 126 has been released from the gas cartridge 124.

### FOREIGN PRIORITY

This application claims priority to European Patent Application No. 22154079.2, filed Jan. 28, 2022, and all the benefits accruing therefrom under 35 U.S.C. § 119, the contents of which in its entirety are herein incorporated by reference.

### TECHNICAL FIELD OF INVENTION

The invention relates to a cartridge-operated fire extinguisher, and particularly to a cartridge-operated fire extinguisher with a spear for piercing a gas cartridge of the fire extinguisher.

### BACKGROUND OF THE INVENTION

Fire extinguishers are safety-critical devices and the regular inspection, maintenance and service of fire extinguishers is therefore important to ensure that they remain operational and safe to use. Such maintenance is typically performed by a skilled service technician and may require disassembly of the fire extinguisher.

There are different types of fire extinguishers such as stored pressure fire extinguishers and cartridge-operated fire extinguishers. Cartridge-operated fire extinguishers typically have a configuration in which a fire suppressant (e.g. liquid, water, dry powder etc.) is stored in a fluid volume of an unpressurised cylinder or housing, and a propellant is stored under pressure in a separate sealed cartridge e.g. a gas cartridge within the cylinder. The top of the cylinder is sealed with a valve body, and the valve body also typically holds the cartridge via screw threading. Activation of a cartridge-operated fire extinguisher therefore firstly requires release of the pressurised fluid propellant in the cartridge into the unpressurised cylinder, which subsequently forces the fire suppressant out of the cylinder through the valve body and into a hose. The hose can then be aimed by a user at a fire to direct fire suppressant at the fire.

It is necessary for a service technician during regular servicing to disassemble and reassemble a cartridge-operated fire extinguisher. The cartridge is removed and may be weighed to ensure that no propellant has leaked out, and/or may be replaced with a fresh cartridge known to contain pressurised propellant fluid. The cartridge is then screwed back into the valve body and rest of the fire extinguisher is reassembled. It is possible that cross-threading between the cartridge and the valve body may result in the cartridge leaking, or the cartridge may simply leak anyway due to flaws in manufacture or general wear over time. The cylinder may therefore become prematurely pressurised, thereby increasing the risk that the fire extinguisher is unsuitable for use (e.g. already spent) in the event of a fire, or even just that there may be an accident when disassembling the unexpectedly pressurised fire extinguisher during servicing.

Improvements in safety in respect of cartridge-operated fire extinguishers are therefore desirable.

### SUMMARY OF THE INVENTION

According to a first aspect of the invention there is provided a cartridge-operated fire extinguisher comprising: a gas cartridge for storing pressurised fluid therein; a spear moveable from an initial first position in a first direction to pierce the gas cartridge, and moveable in a second direction to a second position to thereby indicate that pressurised fluid has been released from the gas cartridge.

The spear (also known as a piercer) therefore serves a dual purpose of firstly readying the fire extinguisher for use by piercing the gas cartridge to charge (i.e. pressurise) the fire extinguisher, and secondly indicating that pressurised fluid has escaped the gas cartridge (e.g. because the gas cartridge has been pierced or has leaked) by being in the second position. The spear is therefore actuable (from the initial first position) in two different directions to achieve its two purposes.

The gas cartridge may be for charging the fire extinguisher ready for immediate use e.g. pressurising the fire extinguisher by releasing the pressurised fluid (i.e. a propellant) so that the fire extinguisher is ready for discharging fire suppressant. The fire extinguisher may be configured to maintain the spear in the initial first position, ready for actuation in either the first direction or the second direction. In use, the spear may therefore move from the initial first position in which the cartridge-operated fire extinguisher is in a steady state (e.g. an equilibrium, ready-to-activate condition) to thereby pierce the gas cartridge. Pressurised fluid may therefore escape the pierced gas cartridge and thereby pressurise a fluid volume of the fire extinguisher for subsequent release of fire suppressant from the fluid volume. The fluid volume may be an internal volume of the fire extinguisher for containing a fire suppressant such as powder, water, fluid or any suitable substance or substances. The fire extinguisher may comprise fire suppressant in the fluid volume. By piercing the pressurised gas cartridge, the fluid volume may thereby be pressurised (i.e. charged) so that fire suppressant may be discharged from the fluid volume and from the fire extinguisher. The gas cartridge may comprise a frangible membrane or other suitable element for sealing pressurised fluid therein unless ruptured by the spear.

The gas cartridge may be fluidly connected to the fluid volume e.g. upstream thereof. The gas cartridge may be within the fluid volume, or may be adjacent to it, or may be proximate to it. The fire extinguisher may comprise a housing (e.g. an outer cylinder) defining the fluid volume, and the gas cartridge may be within the housing. The advantage of this latter configuration is that the gas cylinder may be protected by the housing.

The spear may move in the second direction to the second position e.g. after moving in the first direction and piercing the gas cartridge. The fire extinguisher may be configured so that the spear is moveable in the second direction without having first move in the first direction e.g. in the event that the gas cartridge leaks. The second direction may be opposite the first direction and the spear may therefore move away from the gas cartridge in the second direction. The fire extinguisher may comprise a biasing element (such as a spring or the like) to urge the spear away from the gas cartridge, and/or may be configured so that only pressurised fluid exiting the gas cartridge moves the spear in the second direction. For example, the biasing element may not be able to move the spear all the way to the second position. The biasing element may not even be able to move the spear to the first position. The biasing element may be configured to remove the spear from the gas cartridge in the event that the spear pierces the gas cartridge. The biasing element may therefore help to ensure that the spear does not restrict pressurised fluid from leaving the gas cartridge after it has been pierced.

In addition to moving to the second position after moving firstly in the first direction, the spear may move directly from the first position in the second direction to the second position. The spear may thereby indicate e.g. that the gas cartridge has leaked. Thus, the spear may be configured to move to the second positon upon any release of pressurised fluid from the gas cartridge, whether by puncture by the spear, or by a leak or the like.

The spear may be further from the gas cartridge in the second position than in the first position. Thus, the spear may be in a different location in the second position than in the first position i.e. the second position is different to the first position. A distal end of the spear (i.e. the end furthest from the gas cartridge) may therefore be moved in the second position to a location which is indicative of pressurised fluid having been released from the gas cartridge e.g. by the gas cartridge having being pierced or having leaked. For example, the distal end of the spear may project from a surface of the fire extinguisher (e.g. from a valve body). In short, the spear may ‘pop-out’ when the gas cartridge is open, and thereby simply indicate that the fluid volume is pressurised. It may be dangerous for a service technician to disassemble and service the fire extinguisher while it is pressurised for discharging fire suppressant, and the fire extinguisher comprising the spear as described herein therefore provides a simple means of checking e.g. if the fire extinguisher is pressurised and ready to discharge fire suppressant and/or is unsafe to service. The spear as recited herein may therefore improve safety of the fire extinguisher.

For example, if a user activates the fire extinguisher by actuating the spear in the first direction (by any suitable means such as those discussed herein), then the spear will subsequently move to the second position (i.e. pop-out) and indicate that the fluid volume is pressurised, and hence that the fire extinguisher is ready to discharge fluid suppressant (and also is unsafe to disassemble for servicing). Moreover, if the gas cartridge leaks (without intentional activation of the fire extinguisher) then a service technician can readily determine from visual inspection alone that the fluid volume is charged and hence that the fire extinguisher is unsafe to immediately disassemble. The service technician may therefore depressurise the fluid volume of the fire extinguisher before carrying out the service.

The first position of the spear may be a ready position in which the spear is held stationary and securely (e.g. by friction within a bore as described herein and/or by biasing forces e.g. from one or more seals on the spear) and is ready for actuation in the first direction (e.g. downwards towards the gas cartridge) to pierce the gas cartridge (e.g. by a lever or the like), or ready for actuation in the second direction (e.g. upward away from the gas cartridge) to indicate that pressurised fluid has been released from the gas cartridge. The spear may be held in the first position unless acted on e.g. by a user of the fire extinguisher or by pressurised fluid leaking from the gas cartridge. Thus, the fire extinguisher may be configured so that the spear remains in the initial first position unless the gas cartridge is open.

The spear may remain in the first position unless acted upon by a force greater than a predetermined force threshold. For example, a force greater than the predetermined force threshold may be needed to move the spear out of the first position e.g. in the first direction in order to pierce the gas cartridge, or the second direction to indicate a leak. Thus, the risk of unwanted or accidental activation of the fire extinguisher may be reduced by selecting a suitable predetermined force threshold.

The cartridge-operated fire extinguisher may comprise a valve body comprising a socket. The gas cartridge may be installed in the socket. The fire extinguisher may comprise a pressure chamber in fluid communication with the socket. The pressure chamber may be in the valve body. The spear may be disposed partially within the pressure chamber and configured to move in the second direction when pressure in the pressure chamber exceeds a predetermined pressure threshold.

The gas cartridge may be installed within the socket during assembly and/or service of the fire extinguisher. The socket may be adapted to receive and securely retain the gas cartridge (e.g. by comprising threading, a bayonet coupling, a locking mechanism or any suitable mating arrangement). The pressure chamber may be arranged to receive pressurised fluid from the gas cartridge e.g. after the gas cartridge has been pierced by the spear or if the gas cartridge leaks. The pressure chamber may provide pressurised fluid to the fluid volume of the fire extinguisher for subsequent discharge of fire suppressant. The pressure chamber may be immediately downstream of the gas cartridge e.g. so that fluid exits the gas cartridge into the pressure chamber.

A proximate end of the spear (i.e. the end nearest to the gas cartridge) may therefore be exposed to pressurised fluid exiting the gas cartridge, and the spear may therefore be moveable when the pressure in the pressure chamber exceeds the predetermined pressure threshold (and hence exerts a predetermined force on the spear). Thus, the fire extinguisher may be configured so that the spear will move to the second position if (and only if) pressure within the pressure chamber exceeds the predetermined pressure threshold.

The spear may comprise a marker at an end distal from the gas cartridge, which marker may be visible only when the spear is in the second position. The marker may be a visual marker. The marker may be concealed within the valve body when the spear is in the first position, and may be exposed from the valve body when the spear is in the second position. When the spear is moved to the second position, the distal end of the spear may project from the valve body so that the marker is visible. The marker may therefore provide an easily recognisable indicator that pressurised fluid has been released from the gas cartridge. Thus, a service technician (or any other user) may readily determine the status of the fire extinguisher simply by visual inspection. If the marker is not visible, the fluid chamber is not pressurised, and if the marker is visible then the fluid chamber is pressurised.

The marker may be labelled, coloured and/or shaped as needed so as to be visually distinct e.g. from the rest of the spear. The marker may display a warning flag, symbol, picture, icon or the like. The marker may be different to the rest of the spear. In short, the marker may be readily recognisable as such.

The spear may be disposed within a bore of the valve body and may be positioned so that the marker is within the bore (and therefore not visible) unless pressurised fluid has escaped from the gas cartridge e.g. unless pressure within the pressure chamber (and the fluid volume) is greater than the predetermined pressure threshold. If pressurised fluid has been released from the gas cartridge, then the spear may be moved to the second position so that the marker exits the bore and thereby becomes visible. Thus, the marker may be within the bore (and hence not visible) when the spear is in the first position and outside the bore (and hence visible) when the spear is in the second position.

The fire extinguisher may be configured so that the spear will remain in the second position until a resetting force is applied to it, and then only if pressure within the pressure chamber is below the predetermined pressure threshold. For example, the spear and the bore may be sized so that the spear will remain in the second position, even once the fire extinguisher is no longer pressurised e.g. is at ambient or atmospheric pressure. Thus, once the gas cartridge has been used, the spear may be held in the second position until e.g. the fire extinguisher is serviced. Alternatively, the fire extinguisher may be configured so that the spear moves from the second position once pressure within the pressure chamber falls below a selected threshold e.g. the predetermined pressure threshold. Thus, the spear may serve to either identify that the gas cartridge has been opened, or may indicate that the fire extinguisher is pressurised, as needed.

The spear may comprise a seal, and the seal may provide the marker. The marker may therefore be a seal of the spear. The seal may prevent leakage of fluid (e.g. pressurised fluid) past the spear. The seal may therefore seal pressurised fluid within the pressure chamber of the valve body. The spear may comprise a plurality of seals, and one of the plurality of seals may provide the marker. Thus, one of the seals of the spear may be a marker seal e.g. a coloured O-ring or the like, and hence may be visually distinct from the rest of the spear.

At least one of the seals (e.g. the marker seal) may co-operate with a recess of the valve body (e.g. a recess around an inner circumference of the bore) when the spear is in the first position, to therefore maintain the spear in the first position unless it is acted upon by a force greater than the predetermined force threshold. That is, the seal may seat within a recess of the bore adapted for that purpose to hold the spear in the first position. The predetermined force threshold needed to move the spear from the first position may therefore be the force needed to cause the seal to move out of engagement with the recess.

A different force may be needed to move the spear from the first position in the first direction that that needed to move the spear from the first position in the second direction. For example, it may be more difficult to activate the spear to pierce the gas canister than to move the spear to the second position (or vice versa). For example, the recess may be asymmetric so that a greater force is needed to move it in one of the first direction and the second direction compared to the other. Alternatively, the same force may be needed to move the spear in either direction. In short, the amount of force needed to move the spear in either direction may be predetermined.

The cartridge-operated fire extinguisher may comprise a window arranged so that the distal end of the spear is visible through the window when the spear is in the second position. The window may be in the valve body. Thus, the marker may be visible through the window when the spear is in the second position. A service technician for example, may therefore readily ascertain the status of the gas cartridge by looking through the window and checking whether the marker is visible.

The valve body may comprise a plurality of windows so that the distal end of the spear (and e.g. the marker) is visible from different directions e.g. from opposite directions, from three sides, from all directions etc., when the spear is in the second position. The windows may be on opposite sides of the valve body, and/or may surround the spear on multiple sides.

The spear may comprise a flange arranged to abut a shoulder of the fire extinguisher when the spear is in the second position. The flange may abut a shoulder of the valve body when the spear is in the second position. The flange may not abut the shoulder of the valve body when the spear is in the first position. The flange may prevent the spear moving in the second direction when the spear is in the second position by abutment with the valve body. The location of the flange may determine the second position of the spear, since the spear may travel in the second direction until the flange abuts the shoulder of the valve body. The flange may be disposed within the pressure chamber of the valve body.

The cartridge-operated fire extinguisher may comprise a biasing element arranged to bias the spear away from the gas cartridge. The biasing element may be a spring or any suitable biasing element. The spear may therefore need to move against the biasing force of the biasing element to pierce the gas cartridge. The biasing element may bias the spear in the second direction, and may be provided to move the spear in the second direction once the spear has pierced the gas cartridge e.g. to help ensure pressurised fluid can readily leave the pierced gas cartridge. The biasing element may urge the spear to the second position. Alternatively, although the biasing element may move the spear in the second direction for a portion of the spear's travel, it may not move the spear all the way to the second position. Thus, travel of the spear to the second position may only be achieved by forces from pressure within the pressure chamber. Thus, if the spear is moved in the first direction but not far enough to pierce the gas cartridge, then it will not subsequently move to the second position by action of the biasing element. The biasing element also will not risk prematurely moving the spear to the second position from the first position.

The biasing element may abut the flange of the spear, and may be disposed between the flange and the gas cartridge. The biasing element may have any suitable arrangement to achieve the functions recited herein.

The cartridge-operated fire extinguisher may be configured so that the spear remains in the second position during release of fire suppressant from the fire extinguisher. The spear may therefore remain in the second position after pressurised fluid has been released from the gas cartridge, and may not move in the first direction e.g. until the fire extinguisher has been serviced and reset, and the gas cartridge replaced or refilled. The spear may therefore continue to show by simple visual inspection that the pressurised fluid has been released from the gas cartridge. The spear may remain in the second position at least until pressure within the pressure chamber (and hence the fluid volume) falls below a threshold e.g. the predetermined pressure threshold.

The fire extinguisher may be used to discharge fire suppressant while the spear remains in the second position. It is therefore not necessary to use the spear as a valve element or the like e.g. for controlling discharge of fire suppressant from the fire extinguisher. Thus, the risk of e.g. moving the spear of out the second position when there is insufficient pressure in the fire extinguisher to return it to the second positon, and hence the risk of leaving a used fire extinguisher in place of a charged one, is reduced and the fire extinguisher may be made safer.

The fire extinguisher may comprise a valve element for controlling the discharge of fire suppressant from the fluid volume. The valve element may be operable to change from a first (e.g. closed) configuration to a second (e.g. open) configuration to thereby open the fluid volume and discharge fire suppressant from the fluid volume (when the fluid volume is sufficiently pressurised). The spear may remain in the second position when the valve element is in the first configuration and when the valve element is in the second configuration. The valve element may be distinct from the spear and may operate independently from the spear.

The cartridge-operated fire extinguisher may comprise an activation lever. The spear may be spaced from the activation lever when it is in the first position. The activation lever may be operated by a user in order to drive the spear in the first direction to thereby pierce the gas cartridge. The activation lever may be biased to a predetermined position so that it is spaced from the spear unless it is actuated by a user. The fire extinguisher may therefore be configured so that the spear is provided with clearance allowing it to travel from the first positon to the second positon. Put simply, there may be space for the spear to ‘pop-up’ and thereby show that the gas cartridge has opened. The spear may therefore be closer to the activation lever in the second position than in the first position.

The spear may comprise a fluid channel extending at least a portion of the length of the spear proximate the proximal end of the spear (i.e. the end closest to the gas cartridge). The fluid channel may provide a cross-section of the spear that is narrower (e.g. has a smaller area) than the cross-section at the proximal end, so that pressurised fluid (i.e. propellant) can exit the gas cartridge past the spear via the fluid channel when the spear is partially disposed within (i.e. piercing) the gas cartridge. The spear may comprise a plurality of such fluid channels.

The fire extinguisher may comprise a frangible clip, such as a safety clip, that must be released, deformed and/or broken in order to drive the spear from the first position in the first direction. For example, the fire extinguisher may comprise a safety clip that must be broken in order to move the activation lever to drive the spear from the initial first position in the first direction. Thus, together with the spear, the condition of the fire extinguisher may be determined from visual inspection of the safety clip. For example, if the safety clip is broken and the spear is in the second position, then it may be understood that that the activation lever has been used and the gas cartridge has been opened. Alternatively, if the safety clip is not broken and the spear is in the second position, then it may be understood that the activation lever has not been used, but that the fluid volume is anyway pressurised i.e. that the gas cartridge has leaked. Of course, if the safety clip is not broken and the spear is in the first position, it may be understood that the fire extinguisher is ready for activation and use as needed.

According to a second aspect of the invention there is provided a method of indicating a status of a cartridge-operated fire extinguisher, comprising using pressurised fluid from a gas cartridge of the fire extinguisher to actuate a spear from an initial first position to a second position to thereby indicate that pressurised fluid has been released from the gas cartridge.

The method may comprise inspecting the spear and concluding that pressurised fluid (i.e. propellant) has been released from the gas cartridge if and only if the spear is in the second position. The method may comprise determining that pressurised fluid has not been released from the gas cartridge while the spear is not in the second position.

The method may comprise using pressurised fluid from the gas cartridge to move the spear away from the gas cartridge to the second position. The spear may therefore be further from the gas cartridge in the second position than in the first position. The method may comprise making the spear ‘pop-out’ to show that the gas cartridge has been opened.

The method may comprise actuating the spear from the first position to the second position in the event of a leak of pressurised fluid from the gas cartridge. The method may comprise actuating the spear to the second position upon release of pressurised fluid from the gas cartridge.

The method may comprise actuating the spear in a first direction to pierce the gas cartridge and thereby release pressurised fluid from the gas cartridge. The method may therefore comprise firstly actuating the spear from the initial first position to thereby pierce the gas cartridge, and then actuating the spear to the second position using pressurised fluid from the pierced gas cartridge.

Actuating the spear from the first position to the second position may comprise pressurising a pressure chamber in a valve body of the fire extinguisher to greater than a predetermined pressure threshold. The method may comprise selecting the predetermined pressure threshold based on a pressure at which the fire extinguisher may be safely disassembled.

The method may comprise maintaining the spear in the second position while fire suppressant is discharged from the fire extinguisher. The method may comprise actuating a valve element to release fire suppressant from the fire extinguisher while the spear is in the second position. The method may comprise not using the spear as a valve element or the like to thereby control a flow fire suppressant from the fire extinguisher.

The method may comprise using and/or providing the cartridge-operated fire extinguisher as recited herein with reference to the first aspect of the invention.

According to another aspect of the invention, there is provided a method of servicing, using, and/or providing a fire extinguisher as recited herein with reference to the first aspect of the invention. The method may comprise determining the condition of the fire extinguisher by inspecting the position of the spear. The method may comprise disassembling the fire extinguisher only if the spear is not in the second position. The method may comprise the features of the method of the second aspect of the invention. The fire extinguisher as recited herein with reference to the first aspect of the invention may be configured to perform the method of any aspect of the invention recited herein.

According to another aspect of the invention, there is provided a fire extinguisher comprising a spear moveable from an initial first position to a second position to thereby indicate that the fire extinguisher is pressurised. The fire extinguisher may comprise a cartridge for containing pressurised fluid and releasing pressurised fluid to prepare the fire extinguisher for use. The cartridge may be any suitable cartridge for suitably pressurising the fire extinguisher (e.g. pressuring a fluid volume thereof), but may typically be a gas cartridge containing a pressurised gas. The fire extinguisher may comprise any of the features recited herein with reference to any aspect of the invention.

According to another aspect of the invention there is provided a method of indicating a condition of a fire extinguisher comprising moving a spear of the fire extinguisher from an initial first positon to a second positon to thereby indicate that the fire extinguisher is pressurised. The method may comprise and of the features recited herein with reference to any aspect of the invention.

### BRIEF DESCRIPTION OF THE DRAWINGS

Certain embodiments of the invention are described below by way of example only and with reference to the accompanying drawings in which:

FIG. 1 shows a cartridge-operated fire extinguisher;

FIG. 2 shows a cross-section through the cartridge-operated fire extinguisher of FIG. 1;

FIG. 3 shows a cross-section of a portion of the fire-extinguisher of FIGS. 1 and 2, including a spear in a first position;

FIG. 4A shows the portion of FIG. 3 from an alternative view point;

FIG. 4B shows the portion of FIG. 3 from an alternative view point and with some elements of the fire extinguisher transparent;

FIG. 5 shows a cross-section of the portion of the fire-extinguisher of FIGS. 1 and 2, including the spear in a second position;

FIG. 6A shows the portion of FIG. 5 from an alternative view point; and

FIG. 6B shows the portion of FIG. 5 from an alternative view point and with some elements of the fire extinguisher transparent.

### DETAILED DESCRIPTION OF THE INVENTION

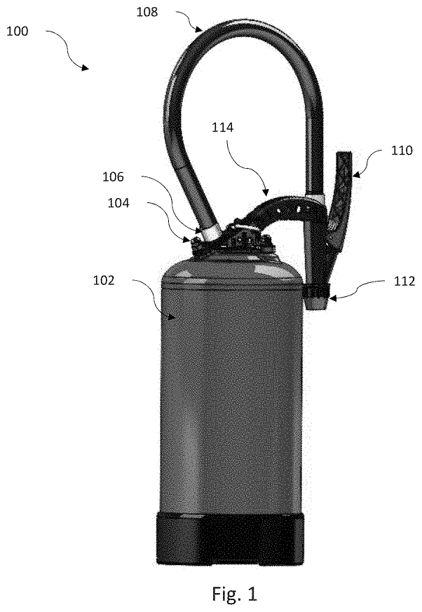

FIG. 1 shows a cartridge-operated fire extinguisher 100. The fire extinguisher comprises a cylinder 102 (or housing) for containing fire suppressant 122, a valve body 104 closing the cylinder 102, a hose connector 106, and a hose 108 connected to the valve body 104 via the hose connector 106. The valve body 104 is mounted on a top of the cylinder 102 to thereby seal cylinder 102. The hose connector 106 is connected to the valve body 104, and the hose 108 is connected to the hose connector 106. In this way, the hose 108 is fluidly connected to a fluid volume 120 within the cylinder 102, and may be used to discharge fire suppressant 122 from the fluid volume 120 in order to combat a fire (provided the fluid volume 120 is suitably pressurised).

The hose 108 comprises a handle 110 and a nozzle 112. An activation lever 114 is connected to the valve body 104 and is operable to activate the fire extinguisher 100 by pressurising the fluid volume 120 as described herein. When the fire extinguisher 100 is not in use, the hose 108 may be mounted on to the activation lever 114 in a storage position. Of course, the hose 108 and handle 110 may be stored in any suitable manner. The hose 108 may be unclipped from the activation lever 114 and directed at a fire during use of the fire extinguisher 100, to thereby direct fire suppressant 122 as it is discharged from the fluid volume 120.

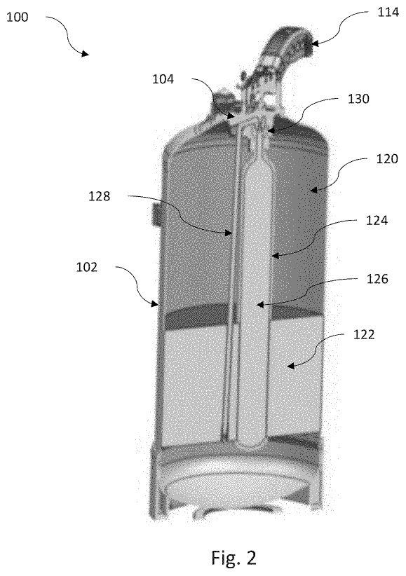

FIG. 2 shows a cross-section through the cartridge-operated fire extinguisher 100 of FIG. 1. The cylinder 102 defines the fluid volume 120 therein, and a fire suppressant 122 is stored within the fluid volume 120. The fire suppressant 122 may be dry powder, liquid, water or any other suitable fire suppressant 122 as required. The cylinder 102 also houses a gas cartridge 124, which gas cartridge 124 is connected to a socket 130 of the valve body 104 so as to be in fluid communication with the fluid volume 120 when it is open. The cartridge 124 comprises a propellant 126 such as pressurised gas. The pressurised fluid propellant 126 in the gas cartridge 124 may be any suitable propellant and may be stored in any suitable state (e.g. gas and/or liquid). The propellant 126 may be carbon dioxide. When the cartridge 124 is opened pressurised fluid propellant 126 will leave the cartridge 124 and flow into the fluid volume 120 to thereby pressurise the fluid volume 120. Fire suppressant 122 may then be sprayed out of the pressurised fluid volume 120 via the valve body 104 and through the hose 108. A dip tube 128 may be provided to supply the suppressant 122 to the valve body 104. A blow pipe may also be provided e.g. where a powder suppressant is used to communicate the propellant 126 from the gas cartridge 124 to the fluid volume 120 and help aerate and agitate the powder.

To open the gas cartridge 124, the fire extinguisher 100 comprises a spear 150 housed within a bore 132 of the valve body 104. The spear 150 is configured to actuate towards the gas cartridge 124 in a first direction, to thereby pierce the gas cartridge 124 e.g. pierce a frangible membrane, a rupture disc, or the like. The spear 150 is also operable to move in a second direction to a second position. The activation lever 114 may be operated by a user in order to drive the spear 150 in the first direction and thereby activate the fire extinguisher 100. For example, a protrusion 115 of the activation lever 114 may contact a distal end 152 of the spear 150 when the activation lever 114 is operated by a user, and thereby drive the spear 150 towards the gas cartridge 124. A gap may be provided between the protrusion 115 and the distal end 152 of the spear 150 so that the when the spear 150 is in the first position.

When the gas cartridge 124 is pierced by movement of the spear 150 in the first direction (typically downwards), the propellant 126 is released through the socket 130 of the valve body 104 into the fluid volume 120 of the cylinder 102. The dip tube 128 is configured to then provide the fire suppressant 122 to the valve body 104, the hose connector 106, and through the hose 108. The nozzle 112 of the hose 108 may then be directed by a user using the handle 110, towards a fire for extinguishing the fire.

Thus, the fire extinguisher 100 may be primed for use by actuation of the spear 150 from the initial first position in the first direction to penetrate the gas cartridge 124 and thereby cause propellant 126 to be released and hence to pressurised the fluid volume 120. The cartridge 124 may comprise a frangible seal, rupture disc, membrane or the like arranged to be broken by the spear 150. Any suitable arrangement may be provided in which the spear 150 is driven to make a hole in the cartridge 124 to release propellant 126.

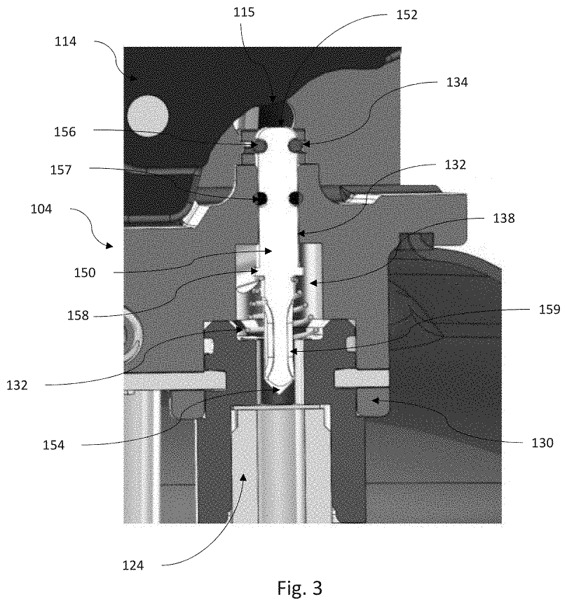

FIG. 3 shows a portion of the fire extinguisher 100 comprising the valve body 104, and the spear 150 in the initial first position. A distal end 152 of the spear 150 (i.e. the end furthest from the cartridge 124) is within the bore 132 of the valve body 104 e.g. flush. A marker seal 156 of the spear 150 is disposed inside the bore 132, and is therefore not visible e.g. by a user or service technician. The marker seal 156 cooperates with a circumferential recess 134 in the bore 132 to hold the spear 150 in the initial first position. The marker seal 156 is an O-ring and is coloured so as to be readily visually distinguishable from the rest of the of the spear 150.

In the depicted fire extinguisher 100, the seal 156 serves as both a seal to help reduce leakage past the spear 150, and a visual marker, but it will be appreciated that any suitable marker may be provided in addition to, or instead of, the seal 156. The spear 150 may comprise a plurality of seals (see e.g. second seal 157 in FIG. 3) so that when the spear 150 moves to the second position sufficient sealing is still provided.

The spear 150 is maintained in the initial first position in the bore 132 by interaction of the marker seal 156 with the recess 134. The seal 156 is seated partially within the recess 134. Thus, in order to move the spear 150 from the first position, a sufficient force greater than a predetermined force threshold must be applied to cause the marker seal 156 to deform and move out of the recess 134. It may also be necessary to overcome a force from the second seal 157, as desired. In short, the spear 150 must be pushed hard enough to make it move from the first position. The spear 150 is therefore held in the first position unless it is subjected to a force greater than the predetermined force threshold. The shape of the seal 156 and the recess 134 can be selected so as to determine the predetermined force threshold.

The activation lever 114 is operable to apply a sufficient force to the spear 150 to move it in the first direction towards the gas cartridge 124. During use, the activation lever 114 is actuated downwards (e.g. by hand) which causes the spear 150 to move, thereby driving a proximal end 154 of the spear 150 (i.e. the end closest to the cartridge 124) in the first direction to pierce the top of the gas cartridge 124. The proximal end 154 of the spear 150 may be shaped for piercing the gas cartridge 124. Propellant 126 is thereby released from the gas cartridge 124 and pressurises the fluid volume 120. A valve element (or any other suitable mechanism) may then open the fluid volume 120, so that entrained fire suppressant 122 is discharged from the pressurised fluid volume 120 of the fire extinguisher 100. The valve element may be disposed in the handle 110, the valve body 104, or any suitable location as required.

A spring 160 is disposed between the gas cartridge 124 and the spear 150, and may abut a flange 158 of the spear 150. The spring 160 therefore biases the spear 150 away from the cartridge 124, and may be operable to move the spear 150 away from the cartridge 124 once the spear 150 has pierced the gas cartridge 124. This may help ensure that propellant 126 quickly exits the cartridge 124 to charge the fluid volume 120, since the spear 150 will not block the hole it makes in the cartridge 124.

The spring 160 may be arranged so that it only moves the spear 150 a portion of its travel away from the gas cartridge 124. The spring 160 may not be arranged to move the spear to the first position.

The spear 150 may comprise a fluid channel 159 running along at least a portion of its length proximate the proximal end 154 (i.e. the end nearest the cartridge 124). The fluid channel 159 ensures that the spear 150 will not fully block the hole it makes in the cartridge 124 even when partially disposed in the cartridge 124 so that propellant 126 can quickly exit the cartridge 124 after it is punctured. The spear 150 may comprise a plurality of such fluid channels 159.

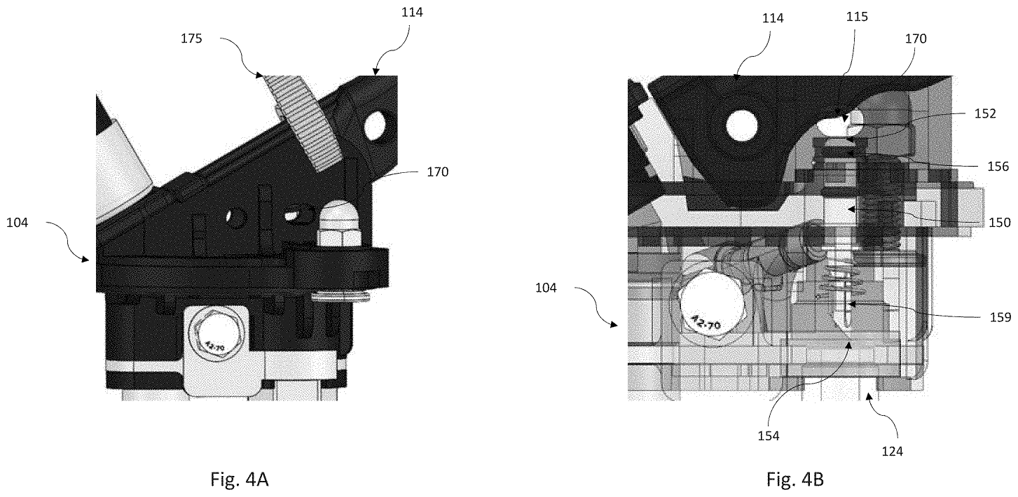

FIG. 4A shows another view of the portion of the fire extinguisher 100. The valve body 104 comprises a window 170 through which the distal end of the spear 150 (and e.g. the marker seal 156) may be visible when the spear 150 is in its second position. A user or a service technician may look through the window 170 to check the position of the spear 150, and thereby check the status of the gas cartridge 124. The spear 150 is not visible in the configuration shown in FIG. 4A.

FIG. 4B shows the same portion of the fire extinguisher 100 with transparent elements, with the spear 150 in the initial first position so that the seal 156 is within the bore 132 and therefore not visible. In this configuration, the fire extinguisher 100 is ready to be activated by a user.

The valve body 104 comprises a pressure chamber 138 immediately downstream of the gas cartridge 124 and upstream of the fluid volume 120. The spear 150 is partially disposed in the pressure chamber 138 and is therefore exposed to fluid pressure therein. Propellant 126 leaving the gas cartridge 124 therefore pressurises the pressure chamber 138, and when the pressure reaches a predetermined pressure threshold it causes the spear 150 to move in the second direction (opposite the first direction) away from the gas cartridge 124. Thus, the spear 150 moves upwards to the second position wherein the flange 158 contacts a shoulder of the valve body 104 e.g. the edge of the pressure chamber 138, and therefore prevents the spear 150 from moving any further in the second direction. The marker seal 156 therefore exits (e.g. pops out) of the bore 132 and becomes visible when the spear 150 is in the second position. The second seal 157 can maintain sufficient sealing when the spear 150 is in the second position. The window 170 in the valve body 104 ensures that the distal end 152 of the spear 150 is visible through the valve body 104. Thus, a user or service technician can conclude that the gas cartridge 124 has opened (and hence that the fluid volume has been pressurised) when the marker seal 156 of the spear 150 is visible.

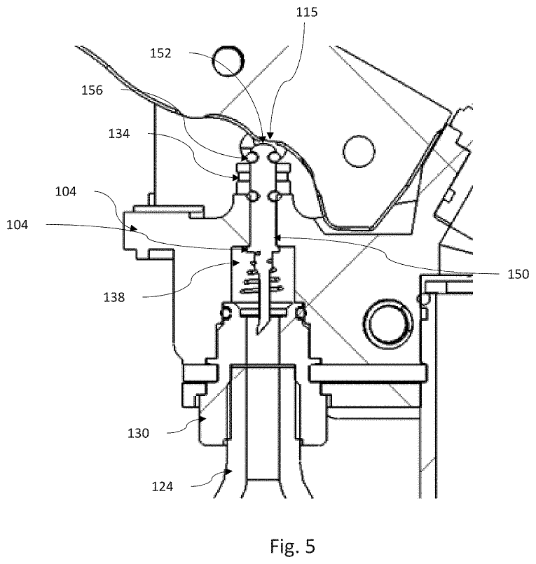

FIG. 5 shows the spear 150 in the second position, with the marker seal 156 outside the bore 132 and therefore visible e.g. through the window 170 of the valve body 104. The spear 150 moves to the second positon when pressure in the pressure chamber 138 exceeds a predetermined pressure threshold and thereby applies a sufficient force to the spear 150. The fire extinguisher 150 is configured so that the spear 150 will only move to the second position if pressure within the pressure chamber 138 exceeds the predetermined pressure threshold. The predetermined pressure threshold may be selected as needed e.g. as that below which the fire extinguisher 100 is safe to disassemble. The predetermined pressure threshold may be above atmospheric pressure. The predetermined pressure threshold may be 1 MPa (Megapascal), 1.5 MPa, 2 MPa, 5 MPa, 7 MPa, 10 MPa, 15 MPa or 20 MPa. The predetermined pressure may be that typically required to suitably pressurise the fluid volume 120 for release of suppressant 122.

In addition to being moved in the second direction after piercing the cartridge 124, the spear 150 may move in the second direction without first moving in the first direction e.g. in the event that the gas cartridge 124 leaks and thereby pressurises the pressure chamber 138. A service technician can therefore readily determine if the gas cartridge 124 has leaked just by a visual inspection of the spear 150. Indeed, the fire extinguisher comprises a safety clip 175 which needs to be removed or broken in order to move the activation lever 114 and thereby activate the fire extinguisher 100. The condition of the safety clip 175 may also be visible to a user or a service technician, and can therefore provide another indicator of the condition of the fire extinguisher 100.

For example, if the safety clip 175 remains in place or in one piece, but the spear 150 is in the second position then it is likely that the activation lever 114 was not moved, but the pressure chamber 138 is nevertheless pressurised, and hence likely that the gas cartridge 124 has leaked. If the spear 150 is in the second position, and the safety clip 175 has been broken, then it is likely that the gas cartridge 124 was punctured by the spear 150. If the safety clip 175 is in place, and the spear 150 is not in the second position, then the fire extinguisher 100 is likely ready to be activated e.g. in the event of a fire. Thus, the condition of the safety clip 175 together with the status of the spear 150 can be used to determine whether the gas cartridge 124 is sealed, has been opened by use of the activation lever 114, or has leaked.

The gap between the distal end 152 of the spear 150 and the protrusion 115 of the activation lever 114 when the spear 150 is in the first position therefore permits movement of the spear 150 in the second direction. That is, there is space for the spear 150 to pop out when the pressure chamber 138 is pressurised.

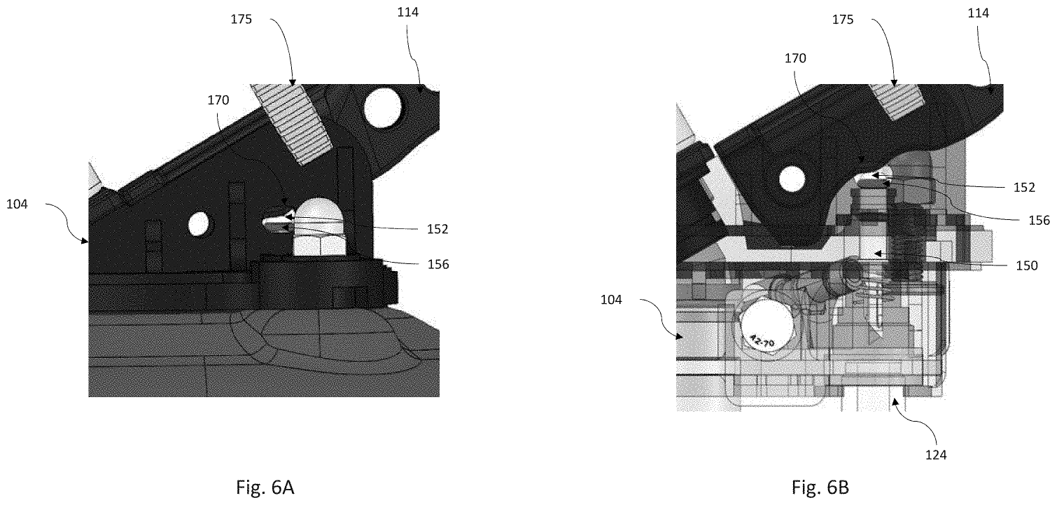

FIG. 6A shows the fire extinguisher 100 with the spear 150 in the second position i.e. popped out from the bore 132. The distal end 152 of the spear 150 and the marker seal 156 are visible through the window 170, and hence the gas cartridge 124 has been opened. Further, the safety clip 175 is in place, and hence it is likely that the lever 114 did not move, and rather the gas cartridge 124 has leaked in order to pressurise the pressure chamber 138.

FIG. 6B shows the same configuration as that of FIG. 6A, but with parts of the fire extinguisher transparent. Again, the spear 150 has moved to the second position and therefore protrudes from the bore 132 of the valve body 104 so that the marker seal 156 is visible. The second seal 157 maintains sufficient sealing of the spear 150 in the bore 132.

The spear 150 therefore provides two functions. Firstly, it is operable to pierce the gas cartridge 124 and thereby make the fire extinguisher 100 ready for use by pressurising the fluid volume 120. It is also operable to move to its second position to thereby show that the fire extinguisher 100 is pressurised.

What is claimed is:

1. A cartridge-operated fire extinguisher comprising:
a gas cartridge (124) for storing pressurised fluid (126) therein; and
a spear (150) moveable from an initial first position in a first direction to pierce the gas cartridge (124), and moveable in a second direction to a second position to thereby indicate that pressurised fluid (126) has been released from the gas cartridge (124).

2. A cartridge-operated fire extinguisher as claimed in claim 1, comprising:
a valve body (104) comprising a socket (130), wherein the gas cartridge (124) is installed in the socket (130); and
a pressure chamber (138) in fluid communication with the socket (130), wherein the spear (150) is disposed partially within the pressure chamber (138) and is configured to move in the second direction when pressure in the pressure chamber (138) exceeds a predetermined pressure threshold.

3. A cartridge-operated fire extinguisher as claimed in claim 1 or 2, wherein the spear (150) comprises a marker (156) at an end distal from the gas cartridge (124), which marker (156) is visible only when the spear (150) is in the second position.

4. A cartridge-operated fire extinguisher as claimed in claim 3, wherein the spear (150) comprises a seal (156), and wherein the seal (156) provides the marker.

5. A cartridge-operated fire extinguisher as claimed in any preceding claim, comprising a window (170) arranged so that the distal end (152) of the spear (150) is visible through the window (170) when the spear (150) is in the second position.

6. A cartridge-operated fire extinguisher as claimed in any preceding claim, wherein the spear (150) comprises a flange (158) arranged to abut a shoulder of the fire extinguisher when the spear (150) is in the second position.

7. A cartridge-operated fire extinguisher as claimed in any preceding claim, comprising a biasing element (160) arranged to bias the spear (150) away from the gas cartridge (124).

8. A cartridge-operated fire extinguisher as claimed in any preceding claim, configured so that the spear (150) remains in the second position during release of fire suppressant (122) from the fire extinguisher.

9. A cartridge-operated fire extinguisher as claimed in any preceding claim, comprising an activation lever (114), wherein the spear (150) is spaced from the activation lever (114) when it is in the first position.

10. A method of indicating a status of a cartridge-operated fire extinguisher, comprising using pressurised fluid (126) from a gas cartridge (124) of the fire extinguisher (100) to actuate a spear (150) from an initial first position to a second position to thereby indicate that pressurised fluid (126) has been released from the gas cartridge (124).

11. A method as claimed in claim 10, comprising actuating the spear (150) in a first direction to pierce the gas cartridge (124) and thereby release pressurised fluid (126) from the gas cartridge (124).

12. A method as claimed in claim 10 or 11, wherein actuating the spear (150) from the first position to the second position comprises pressurising a pressure chamber (138) in a valve body (104) of the fire extinguisher (100) to greater than a predetermined pressure threshold.

13. A method as claimed in any of claim 10, 11 or 12, comprising maintaining the spear (150) in the second position while fire suppressant (122) is discharged from the fire extinguisher (100).

14. A method as claimed in any of claims 10 to 13, comprising using the cartridge-operated fire extinguisher (100) of any of claims 1 to 9.
